(19) United States
(12) Patent Application Publication
(10) Pub. No.: US 2011/0308437 A1
(43) Pub. Date: Dec. 22, 2011

(54) EXTERNAL PULVERIZED COAL CLASSIFIER

(76) Inventors: William Latta, Mooresville, NC (US); Scott Vierstra, Canal Winchester, OH (US)

(21) Appl. No.: 13/162,370

(22) Filed: Jun. 16, 2011

Related U.S. Application Data
(60) Provisional application No. 61/397,903, filed on Jun. 18, 2010.

(51) Int. Cl. F23K 1/00; B07B 1/00

(52) U.S. Cl. 110/232; 209/240

(57) ABSTRACT

An axial classifier for separating the particles of a fluid flow based on the size of the particles. The classifier includes an inlet pipe having a first end and a second end wherein the first end receives the fluid flow from another device and the second end outputs the fluid flow, a reclaim pipe having an opening configured to receive the particles separated from the fluid flow, a reflecting cover provided above the inlet pipe for redirecting the fluid flow exiting the inlet pipe toward the reclaim pipe, and a housing forming a chamber for the fluid flow to flow therein, wherein the housing includes an opening for the fluid flow to exit the classifier. The second end of the inlet pipe is provided above the opening of the reclaim pipe, wherein the particles of the fluid flow are separated in the chamber after existing the reflecting cover.

### CROSS-REFERENCE TO RELATED PATENT APPLICATIONS

This application claims priority to and the benefit of U.S. Provisional Patent Application No. 61/397,903, filed Jun. 18, 2010, the entire disclosure of which is incorporated herein by reference.

### BACKGROUND

The present application relates generally to classifiers for use in the separation of particles according to size or mass. More specifically, the present application relates to static axial classifiers configured to more accurately separate the solid particles of fuel, such as coal, to make the combustion of the fuel more efficient and to reduce undesirable emissions.

It is generally well known to use particle classifiers, such as coal classifiers, in the power industry, such as for use in coal-fired power plants, burning in suspension. Typically, the particle classifier is positioned between a fuel crushing device (e.g., pulverizer) and a fuel combustion device (e.g., boiler, furnace). The coal enters the pulverizer as large irregular pieces and exits transformed into smaller more regular pieces, which are then directed into the classifier. The classifier separates the coal based on particle size or mass, where the larger particles are routed to pass through the pulverizer again for a further reduction in size, and where the smaller particles are directed to exit the classifier and enter the combustion device.

Typically, classifiers have been grouped into two types, static and dynamic. Conventional static classifiers generally involve the use of a fluid (e.g., air, gas) flow to generate centrifugal forces by cyclones or swirling flows to move particles to the periphery walls of the classifier where a combination of gravity and friction overcomes drag forces, which allows the heavier or larger particles to drop out of the flow and be rejected back to the pulverizer. Conventional dynamic classifiers generally involve the use of a rotating classifier blades to generate the centrifugal forces necessary to improve particle classification, wherein the rotating blades may physically impact with particles to reject them from the bulk fluid flow back to the pulverizer. The present application relates to an improved static classifier that more efficiently separates the coarse and fine particles of fuel, such as coal.

An example of a conventional static axial classifier 10 is illustrated in FIG. 1 and includes a housing 11, an inlet pipe 12, an outlet pipe 13, a target cone member 14, a baffle or plurality of blades 15, and a reclaim pipe 16. The housing 11 includes a lower V-shaped portion coupled to the inlet pipe 12 and the reclaim pipe 16, and further includes an upper annular shaped (low velocity) portion coupled to the outlet pipe 13. The cone member 14 resides inside the housing 11, such that the outside surface of the cone member 14 and the inside surface of the housing 11 form a passage for fluid flow 19′ (illustrated by the two arrows between the housing and cone and the two arrows in the inlet pipe). The outside surface of the cone member 14 may couple to the inside surface of the blades 15 and the outside surface of the blades 15 may couple to the inside of the housing 11. The inlet pipe 12 has a smaller cross section (e.g., diameter) than the cross section of the reclaim pipe 16, such that the reclaim pipe 16 couples to the bottom of the lower V-shaped portion of the housing 11 forming an annular portion around the inlet pipe 12.

Pneumatically conveyed pulverized coal enters the lower end of the inlet pipe 12 of the conventional static axial classifier 10, as illustrated by fluid flow 19. The fluid and coal particles exit the inlet pipe 12 and may collide with the outside surface of the cone 14 or the inside surface of the housing 11 while passing through the passage formed between the cone 14 and housing 11. The cross sectional flow area is also increased, slowing the flow. Some coal particles may contact the cone 14 or housing 11 will experience further velocity reductions due to friction off-setting upward drag forces from the fluid flow 19′. If the combination of gravity, friction, and inelastic collisions exceed the drag force created by the fluid flow, then the particles will stagnate and may fall or descend from the passage into the annular portion of the reclaim pipe 16, which transfers the coal back to the pulverizer. Other coal particles are dragged by the fluid flow 19′from the passage through the baffle 15 into the outlet pipe 13 (shown as fluid flow 19″), which ultimately transfers the particles toward the combustion zone, either directly or indirectly, as particles may be stored in a bin. The blades 15 forming the baffle are typically configured to direct the fluid flow 19′ to exit the baffle in the form of a cyclone or vortex, which increases the potential for gravity to overcome the fluid drag forces and allow particles to drop toward the reclaim pipe 16. The larger particles having relative higher momentum and inertia may impact or collide with the blades 15 to slow the particles through inelastic collisions. The imparted swirl, in conjunction with the change in flow direction at the roof of the housing 11, increases the potential for larger particles to impact stationary surfaces, which may slow the particles or redirect the impacted particles flow from the fluid flow direction toward the reclaim pipe 16.

Conventional static axial classifiers, such as the classifier shown in FIG. 1, have several deficiencies, only some of which are described herein. A first deficiency of conventional static axial classifiers is less than optimal separation of the coarsest particles (e.g., greater than 300 microns or micrometers) from the fluid flow relative to total particles passing through the outlet pipe, which may reduce the efficiency of the combustion zone. The fluid flow exiting the inlet pipe travels at high velocities, so the coarse particles may be taken up through the passage without experiencing sufficient off-setting forces (e.g., friction, collisions, gravity) to overcome the fluid drag forces and cause an optimal percentage of the coarse particles to descend back to the reclaim pipe. Also, particles that do experience sufficient off-setting forces to begin descending have to re-enter the higher velocity fluid flow in the vicinity of the inlet pipe (since the reclaim pipe is configured adjacent to the exit of the fluid flow from the inlet pipe), wherein the higher velocity fluid flow may re-entrain ascending coarse particles and direct them back up to and through the baffle. A second deficiency of conventional classifiers is a tendency towards increased unburned coal or char leaving the combustion zone, which can negatively impact the combustion efficiency. It is also more difficult to collect carbon laden fly ash particles in the electrostatic precipitator operation and the quality of the ash byproduct from the combustion process and its beneficial usage in the construction industry is negatively impacted. A third deficiency is the probability of also rejecting an undesirable percentage of fine particles due to the low velocities in the annulus between the target cone section 14 and the housing 11.

With the increased use of combustion staging (internal or external to the primary flames), generally used for the control of the emissions of nitrogen oxides, the top size of particles injected into the combustion zone becomes a greater concern. Since the coal char or fixed carbon oxidizes on the surface exposed to the oxygen, the size of the particle and the particle's surface area to volume or weight ratio influences the overall reaction rate, during combustion. Thus, a smaller or fine particle will oxidize more quickly relative to a larger or coarse particle. Increasing the fraction of fine coal particles relative to total particles injected into the combustion zone, generally, improves the efficiency of combustion and emission control of the nitrogen oxides, while reducing the potential for unburned coal (or char) from leaving the combustion zone.

### SUMMARY

An exemplary embodiment relates to an axial classifier for separating the particles of a fluid flow based on the size of the particles. The classifier includes an inlet pipe having a first end and a second end wherein the first end receives the fluid flow from another device and the second end outputs the fluid flow, a reclaim pipe having an opening configured to receive the particles separated from the fluid flow, a reflecting cover provided above the inlet pipe for redirecting the fluid flow exiting the inlet pipe toward the reclaim pipe, and a housing forming a chamber for the fluid flow to flow therein, wherein the housing includes an opening for the fluid flow to exit the classifier. The second end of the inlet pipe is provided above the opening of the reclaim pipe, wherein the particles of the fluid flow are separated in the chamber after existing the reflecting cover.

Another exemplary embodiment relates to a power plant for producing electric power from the combustion of a fuel source. The power plant includes a pulverizer configured to reduce the particle size of the fuel source input into the pulverizer, a combustion device having an igniter and a combustion chamber wherein the igniter provides the heat to initiate the combustion of the fuel in the combustion chamber, and an axial classifier. The axial classifier is configured to separate the particles of fuel of a fluid flow received from the pulverizer, in order to transfer the separated coarse particles back to the pulverizer and to transfer the fine particles to the combustion device. The axial classifier includes an inlet pipe, a reflective cover, a deflecting member, a reclaim pipe fluidly coupled to the pulverizer, a fluid flow guide and a housing forming a chamber for the fluid flow to pass therein. The inlet pipe directs the fluid flow received from the pulverizer upwardly toward the reflective cover. The reflective cover redirects the fluid flow downwardly toward the deflecting member and reclaim pipe. The fluid flow guide is coupled to the housing and configured to influence the direction of the fluid flow, wherein the coarse particles are separated from the fluid flow and enter the reclaim pipe to pass back through the pulverizer to be resized, and wherein the fine particles of the fluid flow remain in the fluid flow and are redirected upwardly by the deflecting member toward an opening in the housing to pass into the combustion device.

### BRIEF DESCRIPTION OF THE DRAWINGS

FIG. 1 is a front sectional view of a conventional static axial classifier.

FIG. 2 is a front sectional view of an exemplary embodiment of a static axial classifier illustrating the fluid flow within.

FIG. 3 is another front sectional view of the classifier of FIG. 2, including the adjustment components used to tune the operation of the classifier.

FIG. 4 is a computational fluid dynamic (CFD) simulation illustrating the internal static pressure gradient of the conventional classifier.

FIG. 5 is a CFD simulation illustrating the internal static pressure gradient of the classifier of FIG. 2.

FIG. 6 is a CFD simulation illustrating the velocities of fluid internal to the conventional classifier.

FIG. 7 is a CFD simulation illustrating the velocities of fluid internal to the classifier of FIG. 2.

FIG. 8 is a CFD simulation illustrating the concentration of the trajectories of the coarse particles of coal internal to the conventional classifier.

FIG. 9 is a CFD simulation illustrating the concentration of the trajectories of the coarse particles of coal internal to the classifier of FIG. 2.

FIG. 10 is a Rosin-Rammler Plot illustrating a sample of measured inlet and outlet conditions for a conventional classifier operation and corroborated with CFD modeling, and the CFD classifier modeling for the classifier represented in FIG. 2.

FIGS. 11 and 12 illustrate dimensions of an exemplary embodiment of a static axial classifier according to an exemplary embodiment.

FIG. 13 is a front sectional view of another exemplary embodiment of a static axial classifier.

FIG. 14 is a chart that illustrates the percentage of particles passing downstream over the particle size range in microns.

FIG. 15 is a chart that illustrates the percentage of rejected particles back to be reground over the particle size range in microns.

FIG. 16 is a front sectional view of another exemplary embodiment of a reflecting cover and inlet tube for use in a static axial classifier.

### DETAILED DESCRIPTION

The static axial classifiers described herein improve coarse particle separation efficiency over conventional classifiers, by reducing or eliminating the fraction of coarse particles relative to total particles that exit the classifier and hence are introduced to the combustion zone. The classifiers increase the fraction of fine particles relative to total particles entering the combustion zone, since a reduction in the mean particle size generally improves the efficiency of the combustion device, reduces the amount of undesirable emissions, and reduces the fraction of particles that exit the combustion zone unburned. The static axial classifiers disclosed herein increase the proportion of fine particles reaching the combustion zone by more efficiently separating the coarse particles from the fluid flow within the classifier and returning the coarse particles to the pulverizer for additional size reduction. The static axial classifiers disclosed herein are preferably for use in coal power plants to separate coal particles received from a pulverizer and transferred to a combustion zone, however it should be noted that these axial classifiers may be utilized for separating any material comprising a powder or a combination of particles for use in any industry.

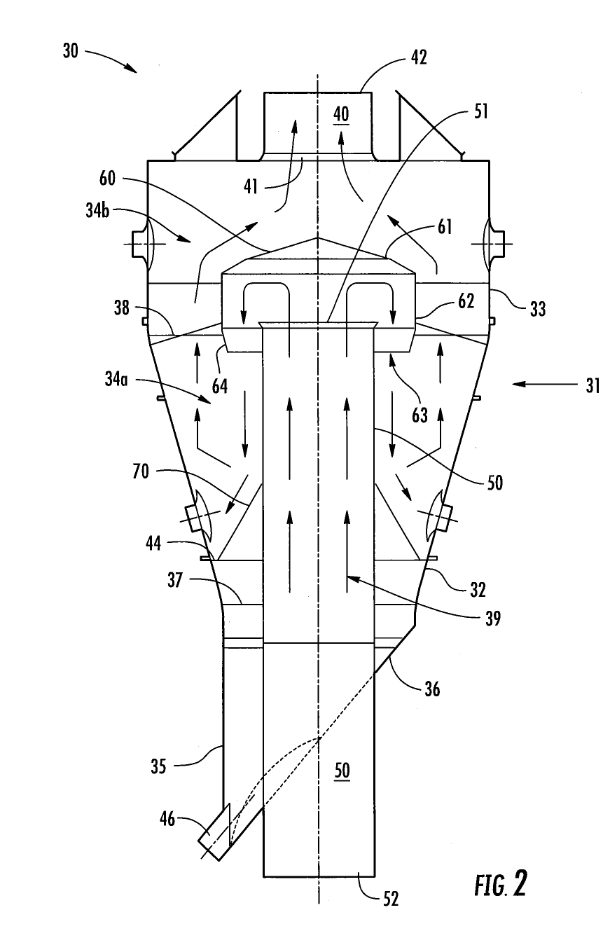

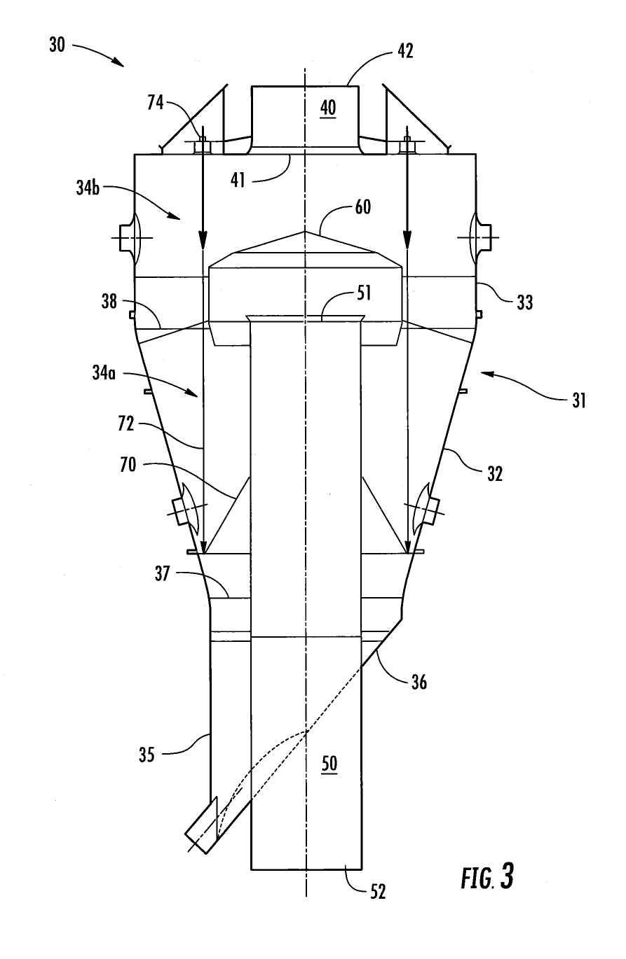

FIGS. 2 and 3 illustrate an exemplary embodiment of an axial classifier 30 that is shown to include a housing 31, a reclaim pipe 35, an outlet pipe 40, an inlet pipe 50, a reflecting cover 60, and a deflecting member 70. The classifier 30 may be configured to include a plurality of outlet pipes 40, wherein each outlet pipe 40 of the plurality of outlet pipes may direct a portion of the fluid flow toward one or more combustion zones. The housing 31 may be made from any suitable material strong and durable enough to withstand the potential internal pressure, impact and abrasion from high velocity coal particles. According to an exemplary embodiment, the housing 31 may include an annular shaped upper portion 33 and a conical (e.g., having a V cross section) shaped lower portion 32. The upper portion 33 of the housing 31 may couple to the outlet pipe 40, and the lower portion 32 of the housing 31 may couple to the reclaim pipe 35. The housing 31 may enclose a portion of the inlet pipe 50 and the reflecting cover 60, wherein a first chamber 34a is formed between the inside surface of the housing 31 and the outside surface of a portion of the inlet pipe 50 and a second chamber 34b is formed between the inside surface of the housing 31 and the outside surface of the reflecting cover 60. The chambers 34a, 34b may be configured for a fluid, such as air along with particles of a fuel (e.g., coal), to flow therethrough. For example, a fluid flow 39 may pass from the reflecting cover 60 through the first chamber 34a, wherein coarse particles are separated from the fluid flow 39. Then the fluid flow 39 may be directed upwardly from the first chamber 34a to the second chamber 34b, wherein additional remaining coarse particles may be separated from the fluid flow 39 to descend to be reclaimed, while the fluid flow 39 exits the classifier 30 through the outlet pipe 40.

The outlet pipe 40 may be strong and durable enough to withstand the potential internal pressure, impact and abrasion from high velocity coal particles. According to an exemplary embodiment, the outlet pipe 40 may be configured to pass fluid flow containing particles of fuel (e.g., coal) from the classifier 30 to either a storage bin or to the combustion zone, and includes a lower end 41 (or first end) and an upper end 42 (or second end). The lower end 41 of the outlet pipe 40 may couple to the upper portion 33 of the housing 31, and the upper end 42 may couple to a storage bin, to the combustion zone or to another pipe connected (e.g., fluidly coupled) to the combustion zone. The outlet pipe 40 may also be integrally formed with the housing 31, such that the upper end 42 has an opening that is configured to pass the fluid flow to the combustion zone either directly or through another pipe.

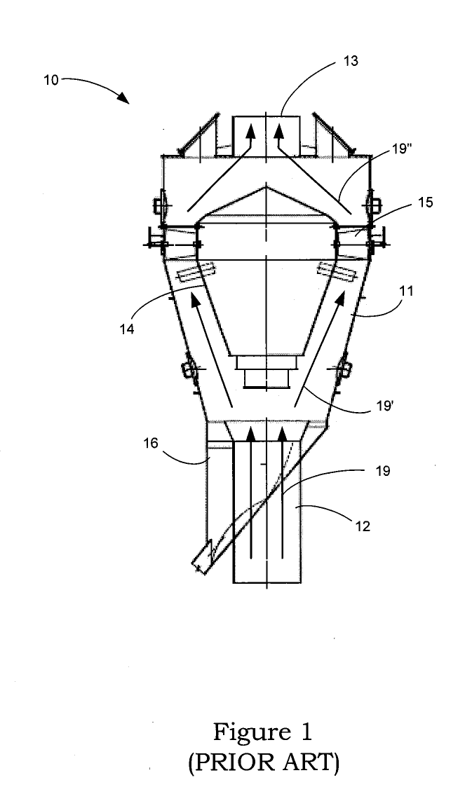

The inlet pipe 50 may be strong and durable enough to withstand the potential internal pressure, impact and abrasion from high velocity coal particles. According to an exemplary embodiment, the inlet pipe 50 may be configured to pass fluid flow 39 containing particles of fuel (e.g., coal), and may pass inside the reclaim pipe 35 and within at least a portion of the housing 31, such as the lower portion 32. The inlet pipe 50 may include a lower end 52 (or first end) configured to receive pressurized fluid and coal particles from a pulverizing device (e.g., pulverizer) and an upper end 51 (or second end) configured to output the fluid, including the coal particles, in an upward direction toward the reflecting cover 60. The upper end 51 of the inlet pipe 50 may be higher relative to the entrance 37 of the reclaim pipe 35. This configuration addresses the deficiency of conventional classifiers, which have the upper end of the inlet pipe configured relatively adjacent to the entrance of the reclaim pipe, such as shown in FIG. 1, where in order for the coarse particles to be reclaimed, the particles have to pass back through the higher velocity fluid flow and are re-exposed to the drag forces of the fluid flow, where often the high velocity fluid flow may re-entrain coarse particles, carrying the particles back up the passage to exit the outlet pipe.

The reflecting cover 60 may be strong and durable enough to withstand the potential internal pressure, impact and abrasion from high velocity coal particles. According to an exemplary embodiment, the reflecting cover 60 may include a top surface 61, an annular side wall 62, and an aperture or opening 63. The reflecting cover 60 may include a plurality of apertures or openings 63. The top surface 61 of the reflecting cover 60 may couple to the annular side wall 62 and may be a concave/convex shaped surface to deflect and re-route the fluid flow. According to an exemplary embodiment, the annular side wall 62 may have a substantially uniform diameter. According to another exemplary embodiment, the annular side wall 62 may have a varying diameter. For example, the annular side wall 62 may extend at an oblique angle towards the inlet pipe 50, thus forming a downwardly funneling or conical shaped exit portion 64. This configuration may increase the velocity of the fluid flow exiting the aperture 63 of the reflecting cover 60. According to an exemplary embodiment, the reflecting cover 60 may be open in the bottom, forming an aperture or opening 63 for receiving a portion of the upper end 51 of the inlet pipe 50. According to another exemplary embodiment, the upper end 51 of the inlet pipe 50 may end short of the opening 63 formed by the lack of a bottom surface of the reflecting cover 60.

According to yet another exemplary embodiment, the reflecting cover 60 may include a bottom surface (or bottom portion) that may couple to the upper end 51 of inlet pipe 50. The bottom surface (or bottom portion) may include one or a plurality of openings (or apertures) 63 to permit fluid flow 39 to pass. The bottom surface (or bottom portion) may also be configured as a baffle having a plurality of fins or blades to direct and regulate the fluid flow. The plurality of fins of the bottom portion may be separated by a plurality of openings (or apertures) 63, wherein the fins are aligned at a similar (or unique) oblique angle (relative to vertical) to control the direction of fluid flow 39 that exits the reflecting cover 60. The plurality of obliquely aligned fins of the bottom portion of the reflecting cover 60 may cause the fluid flow 39 to exit the reflecting cover 60 in the form of a cyclone or vortex to induce impact of the particles of the fluid flow 39, such as with each other, with the outside wall of the inlet pipe 50, and/or with the deflecting member 70. The drag forces acting on the coarse particles may be overcome by these impacts (e.g., with other particles, with the input pipe, with the deflecting member, with the housing, etc.), thereby causing the coarse particles to separate from the fluid flow 39 and descend to the reclaim pipe 35 of the classifier 30 to be redirected for additional size reduction, such as by the pulverizer.

The reflecting cover 60 is configured to redirect the fluid flow 39 containing coal particles from the substantially upward direction as carried through the inlet pipe 50 to the substantially downward direction when exiting through aperture 63 of the reflecting cover 60. The reflecting cover 60 may direct the fluid flow 39 at an oblique downward angle away from the reflecting cover 60. According to an exemplary embodiment, the reflecting cover 60 may direct the fluid flow 39 containing particles in a substantially downward direction along the outside surface or wall of the inlet pipe 50 toward the deflecting member 70.

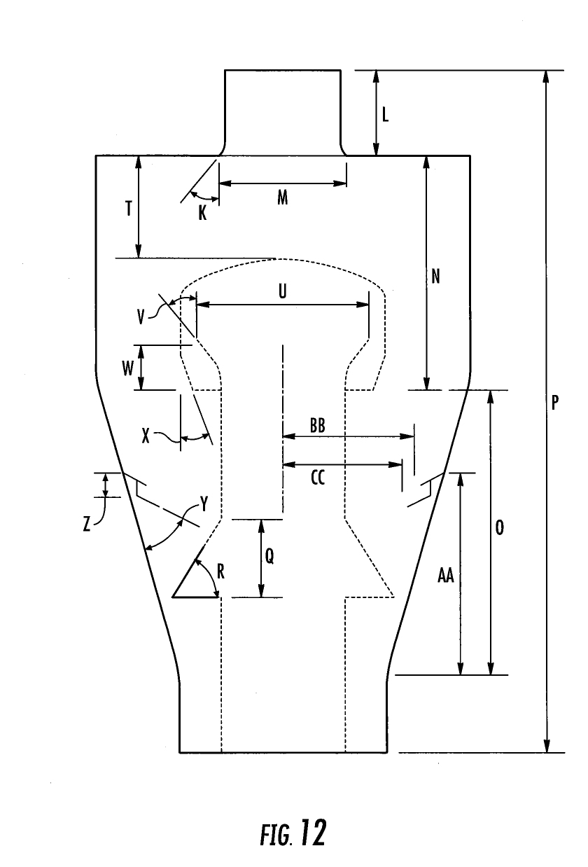

The exit portion 64 of the reflecting cover 60 may be shaped to minimize the pressure drop losses at the flow transition from inside the reflecting cover 60 to below the reflecting cover 60. For example, the exit portion 64 may be flared, having a linear or curved shaped that extends away from the annular side wall 62. The shape of the exit portion 64 of the reflecting cover 60 may vary. As shown in FIG. 13, the exit portion 264 may extend a longer distance from the side wall, or may be configured to have a curved portion extending therefrom. Similarly, the upper end 51, 251 of the inlet pipe 50, 250 and/or the lower end 41, 241 of the outlet pipe 40, 240 may be configured to minimize the pressure drop losses at the flow transition, such as by having a shape (e.g., flare, curve, angle, etc.) to mitigate the pressure drop.

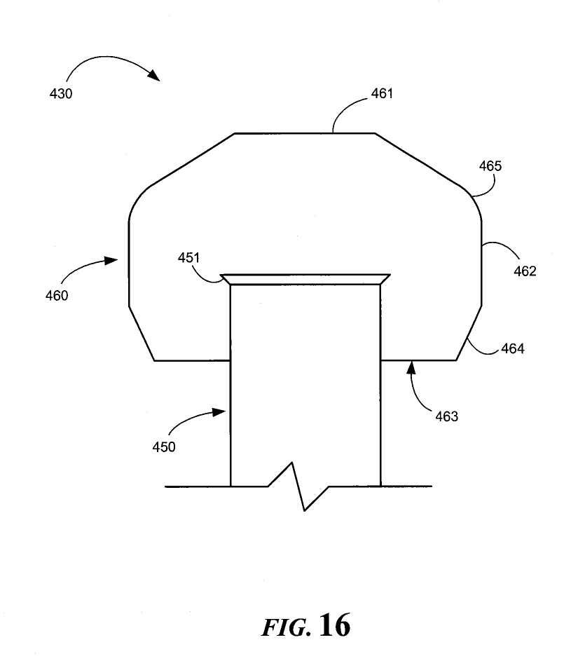

According to the exemplary embodiment shown in FIG. 16, the reflecting cover 460 may include an exit portion 464 (e.g., an exit surface) and a bottom portion 463 (e.g., a bottom surface) provided below the exit portion 464, wherein the bottom portion 463 may be coupled to the upper end 451 of inlet pipe 450. The bottom portion 463 may include one or more openings that permit the fluid flow received from the inlet pipe 450 to exit the reflecting cover 460 of the classifier 430. The reflecting cover 460 may also include a flat top portion 461, an annular side wall 462 and a transition portion 465 that includes curved portion and a generally linear portion.

The deflecting member 70 may be strong and durable enough to withstand the potential internal pressure, impact and abrasion from high velocity coal particles. According to an exemplary embodiment, the deflecting member 70 may extend at an adjustable oblique angle from the outer surface or wall of the inlet pipe 50 towards the inside surface or wall of the housing 31, where a gap 44 may formed between the housing 31 and the deflecting member 70 to allow coarse particles to pass through the gap 44 to enter the reclaim pipe 35.

The classifier may further include a linkage 72 and an adjustment mechanism 74, as shown in FIG. 3. According to an exemplary embodiment, the linkage 72 may couple to the deflecting member 70 at one end and may couple to the adjustment mechanism 74 at the other end, such that by actuation of the adjustment mechanism 74, through the linkage 72, may vary the angle of offset of the deflecting member 70 relative to the inlet pipe 50. The oblique angle of the deflecting member 70 may be increased or decreased to change the size of coal particle that may be reclaimed (i.e., pass through the reclaim pipe 35) or pass to the outlet pipe 40. For example, the oblique angle of the deflecting member 70 may be decreased relative to the inlet pipe 50 to modify the classifier 30 to separate particles of relative smaller size. Therefore, the classifier 30 may be configured to separate coal particles greater than 300 microns, but may be varied, for example, to separate coal particles greater than 180 microns. The classifier may have a broad range of adjustment to separate a broad range of particle sizes, and the examples disclosed herein are not meant to be limitations, but rather illustrations of certain possibilities.

The adjustment mechanism 74 and linkage 72 may be configured using any method for providing remote adjustment. For example, the linkage may include a threaded shaft that treads into the deflecting member 70 and has a handle as an adjustment mechanism 74 fixed to the other end of linkage 72. Rotating the adjustment mechanism 74 rotates the linkage 72, causing the deflecting member 70 to displace along the length of the linkage 72 driven by the treads, causing the end of the deflecting member 70 coupled to the linkage 72 to raise or lower (depending on the direction of rotation of the adjustment mechanism 74), while the other end of the deflecting member 70 may be fixed to the inlet pipe 50. Thus, rotation of the adjustment mechanism 74 may displace the end of the deflecting member 70 relative to the fixed end, while the fixed end remains stationary, therefore changing the angle of the deflecting member 70 relative to the inlet pipe 50 and housing 31. Alternatively, the adjustment mechanism 74 may displace or adjust the linkage 72 using any suitable method, such as using solenoids, fluid pressure or linear electric actuators.

According to another exemplary embodiment, the classifier 30 may include a linkage 72 and an adjustment mechanism 74, wherein the linkage 72 may couple to the deflecting member 70 at one end and may couple to the adjustment mechanism 74 at the other end. Adjustment (e.g., actuation) of the adjustment mechanism 74, may vary the elevation (e.g., height) of the deflecting member 70 relative to the inlet pipe 50 and the reflective cover 60, such as through the linkage 72. In other words, the position (e.g., the height) of the deflecting member 70 relative to the inlet pipe 50 may be adjusted, such as by actuation of the adjustment mechanism 74. The elevation (e.g., height) of the deflecting member 70 may be varied (e.g., increased, decreased) to influence the size of the particle that may be reclaimed by passing through the reclaim pipe 35 and/or that may pass through the outlet pipe 40. The classifier 30 may have a broad range of adjustment of the elevation of the deflecting member 70. For example, the linkage 72 may be threaded to the housing 31, wherein the rotation of the linkage 72 may move the end of the linkage 72 that is coupled to the deflecting member 70 in a linear (e.g., upward, downward) direction (depending on the direction of rotation of the linkage 72). Accordingly, the rotation of the adjustment mechanism 74 may in-turn rotate the linkage 72, such as relative to the housing 31, to move (e.g., displace) the linkage 72 to thereby adjust the elevation of the deflecting member 70.

The classifier may further include a support plate 38, which may be strong and durable enough to withstand the potential internal pressure, impact and abrasion from high velocity coal particles. The support plate 38 includes an outer surface coupled to the housing 31, and an inner surface coupled to the reflecting cover 60. The support plate 38 may provide structural support to the classifier 30 by maintaining the position of the reflecting cover 60 relative to the housing 31. According to an exemplary embodiment, support plate 38 may be annular shaped having an outer diameter which is coupled to the inside surface of the housing 31 and an inner diameter which is coupled to the outside surface of the side wall 62 of the reflecting cover 60. The support plate 38 may include a plurality of apertures to allow fluid flow 39 to pass therethrough without tailoring the direction of fluid flow. According to another exemplary embodiment, the support plate may be configured as a baffle having a plurality of fins or blades to tailor the direction of the fluid flow. Thus, the support plate may be configured to provide an additional (e.g., as second) method of particle separation.

The fluid flow 39 is illustrated in FIG. 2 by arrows indicating the general direction of flow of fluid within the classifier 30. The fluid flow 39 is also meant to illustrate the flow of particles of fuel, such as coal, within the pressurized fluid. According to an exemplary embodiment, the fluid flow 39 enters the classifier 30 through the lower end 52 (or first end) of the inlet pipe 50 and passes through the inlet pipe 50, exiting the upper end 51 (or second end) traveling in a substantially upward direction. The reflecting cover 60 then redirects the fluid flow 39 into a substantially downward direction, where the fluid flow 39 exits the bottom of the reflecting cover 60 flowing toward the deflecting member 70. When the fluid flow 39 is turned from the substantially upward direction to the substantially downward direction by the reflecting cover 60, the relative inertia of the particles causes separation of the particles, wherein the larger (and heavier) particles with higher inertia forces tend to congregate along the inner surfaces of the reflecting cover 60, while the finer (and lighter) particles with lower inertia forces tend to move within the fluid flow streamlines, which are offset from the inner surfaces of the reflecting cover 60. Additionally, the contour (e.g., arc, curve) of the exit of the reflecting cover 60 (e.g., the openings 63) may direct the coarse particles toward the outside surface of the inlet pipe 50 to generate forces (e.g., friction) through collisions to prevent the coarse particles from being reentrained by the drag forces of the fluid flow to allow the coarse particles to pass through the reclaim gap 44 and into the reclaim pipe 35.

As the fluid flow 39 travels downwardly, the velocity of the fluid flow may decrease, wherein the coarse particles may be separated from the fine particles that remain in the fluid flow through inertia (i.e., the resistance of the particles to change direction), gravity, friction, and inelastic collisions. Since the inertia of the particle, as well as the force induced by the acceleration of the particle, is effected by the mass of the particle, the coarse particles separate from the fluid flow by continuing to travel downwardly after contacting the inlet pipe 50, the housing 31 and/or the deflecting member 70 wherein the coarse particles enter the reclaim pipe 35 through the entrance 37 after passing through the gap 44. The inertia or momentum of the coarse particles coupled with gravity overcomes the drag forces of the fluid flow, allowing the coarse particles to pass to the reclaim pipe 35 for additional size reduction, such as in a pulverizer. However, the drag forces from the fluid flow turns the fine particles in a substantially vertical or in the upwardly direction to pass through the support plate and pass out the outlet pipe 40 toward the combustion zone. The inertia or momentum of the fine particles flowing in a downward direction may be overcome by the drag force of the fluid flowing in the upward direction, such that the fluid drives the fine particles upward with the pressurized fluid.

As shown in FIG. 13, the classifier 230 may include a housing 231, a reclaim pipe 235, an outlet pipe 240, an inlet pipe 250, and a reflecting cover 260, wherein the position (e.g., elevation) of the reflecting cover 260 may be adjusted, such as to influence separation of the coarse particles from the fluid flow passing through the classifier 230. The classifier 230 may include an adjustment mechanism 274 and a linkage 272 coupled to the reflecting cover 260 on one end and to the adjustment mechanism 274 on the other end, wherein adjustment of the adjustment mechanism 274 may move the linkage 272 to thereby change the elevation of the reflecting cover 260. The adjustment mechanism 274 and linkage 272 may be multi-directional (e.g., bidirectional) to provide adjustment of the reflecting cover 260 in more than one direction. For example, the adjustment mechanism 274 may be rotated in a first direction (e.g., clockwise) wherein the linkage 272 and coupled reflecting cover 260 may move in an upwardly direction to raise the relative elevation of the reflecting cover 260, and the adjustment mechanism 274 may also be rotated in a second direction (e.g., counter-clockwise) wherein the linkage 272 and coupled reflecting cover 260 may move in a downwardly direction to lower the relative elevation of the reflecting cover 260.

The elevation (e.g., height) of the reflecting cover 260 may be varied (e.g., raised, lowered) to influence the size of the particle that may be separated from the fluid flow. The classifier 230 may allow a broad range of adjustment of the elevation of the reflecting cover 260. For example, the linkage 272 may be threaded to the housing 231, wherein the rotation of the linkage 272 may move the end of the linkage 272 that is coupled to the reflecting cover 260 in a linear (e.g., upward, downward) direction (depending on the direction of rotation of the linkage 272). Accordingly, the rotation of the adjustment mechanism 274 may in-turn rotate the linkage 272, such as relative to the housing 231, to move (e.g., displace) the linkage 272 to thereby adjust the elevation of the reflecting cover 260.

The classifier 230 may also include an adjustment mechanism 274 and/or a linkage 272 coupled to the reflecting cover 260 to adjust the cross-sectional area in which the fluid flow exits the reflecting cover 260. For example, the classifier 230 may be configured such that adjustment of the adjustment mechanism 274 may move the linkage 272 to thereby change (e.g., increase, decrease) the cross-sectional area of the exit of the reflective cover, such as by adjusting the reflecting cover 260 relative to the inlet pipe 250 and/or the housing 231. The fluid flow exiting the reflective cover 260 may be influenced by the adjustment of the cross-sectional area at the exit. For example, the reflective cover 260 may be adjusted to provide a Venturi effect on the fluid flow, whereby the velocity of the fluid flow may be increased with a corresponding reduction in the surface area at the exit of the reflective cover 260 or the velocity of the fluid flow may be decreased with a corresponding increase in the surface area. The ability to vary the cross-sectional area at the exit of the reflective cover 260 of the classifier 230, such as between the end of the exit portion 264 of the reflective cover 260 and the outside of the inlet pipe 250, allows the velocity and pressure (e.g., static) of the fluid flow exiting the reflective cover 260 to be varied to tailor the performance (e.g., classification) of the classifier 230.

The classifier 230 may also include a support plate 238 that is provided between the housing 231 and the reflecting cover 260. The support plate 238 may support the reflecting cover 260 to help the reflecting cover 260 maintain a concentricity to the inlet pipe 250, while allowing the reflecting cover 260 to move (e.g., upwardly, downwardly) relative to the support plate 238 to allow adjustment of the elevation of the reflecting cover 260. The support plate 238 and/or the reflecting cover 260 may include a bearing or have a bearing surface to allow efficient relative movement between them.

The classifier 230 may also include a fluid flow guide to help turn the fluid flow (and entrained fine particles) upwardly toward the outlet pipe 240 and/or to capture coarse particles to be reclaimed. As shown in FIG. 13, the classifier 230 may include a first fluid flow guide 277 and a second fluid flow guide 278 provided below the first fluid flow guide 277. The first fluid flow guide 277 may be shaped as a fin or vein, may be triangular in shape, or may form any suitable shape. The first fluid flow guide 277 may extend from the inner surface of the housing 231 in an angle of alignment (e.g., relative to vertical) that may slant downwardly, and may be positioned vertically (i.e., from a height or elevation perspective) between a deflecting member 270 and the bottom portion of the reflecting cover 260. The angle of alignment of the first fluid flow guide may be any suitable angle between zero (0) and ninety (90) degrees, and, for example, may be between thirty (30) and sixty (60) degrees. The second fluid flow guide 278 may extend at a similar or different angle of alignment with respect to the angle of alignment of the first fluid flow guide 277, and may have a shape that is similar or different from the shape of the first fluid flow guide 277. The second fluid flow guide 278 may be coupled to the housing directly, or may be coupled directly to the first fluid flow guide 277 where there may be a gap between the inner surface of the housing 231 and the second fluid flow guide 278.

The fluid flow guides 277, 278 may help direct the fluid flow that enters the first chamber 234a (from the reflecting cover 260) upwardly toward the second chamber 234b to exit the classifier 230 through the outlet pipe 240. The fluid flow guides 277, 278 may turn the fluid flow, including the fine particles flowing therein, from the downwardly direction to the upwardly direction within the first chamber 234a. Additionally, the fluid flow guides 277, 278 may capture the coarse particles, which may get caught under the fins or veins, to separate the coarse particles to be reclaimed. It should be noted that the classifiers, as disclosed herein, may include any number of fluid flow guides having any suitable configuration and location within the classifier, and those embodiments shown and described herein are not meant as limitations.

The classifier 230 may also include a deflecting member 270, which may extend at an oblique angle from the outer surface of the inlet pipe 250 toward the inner surface of the housing 231. The deflecting member 270 may work alone or in conjunction with the fluid flow guides 277, 278 to help direct the fluid flow upwardly, while separating the coarse particles to be reclaimed.

The classifier disclosed herein advantageously utilizes the natural segregation of particles from the conveying medium streamline through a 180 degree change in direction. In the process, particle momentum and inertia, coupled with gravity and conveying medium velocities, are used to preferentially keep the finer (and lighter) particles entrained in the fluid flow 39, while rejecting the coarser (and heavier) particles in the process. For example, the coarse particles (e.g., particles having sizes greater than 300 microns) may be rejected in order to be reprocessed to reduce the size of the coarse particles. It should be noted that although the coarse particles are described above as particles having sizes greater than 300 microns, the classifiers disclosed herein may be configured (e.g., adjustable) to separate coarse particles having sizes that are less than 300 microns. For example, the classifiers disclosed herein may be configured to separate particles having sizes greater than 250 microns. The design velocities of the conveying medium through the classifier are such that the pressure drop through the classifier is nominally very small, particularly in comparison to swirling classifiers and dynamic classifiers. Similarly, the upper end 51, 251 (or outlet end) of the inlet pipe 50, 250 and/or the lower end 41, 241 (or inlet end) of the outlet pipe 40, 240 may be configured to minimize pressure drop losses at these flow transitions, such as by having contoured (e.g., curved, flared, angled) shapes.

The classifiers disclosed herein, such as classifier 30, are more efficient at separation (i.e., have a higher reclaim percentage of coarse sized particles and higher percentage of fine sized particles entering the outlet pipe) relative to conventional axial classifiers. This increased separation efficiency leads to an increased combustion efficiency, since the size of the particle and the surface area to weight or volume ratio of the particle effect reaction rates during combustion. The increased separation efficiency also generally reduces the carbon content of the fly-ash.

The reclaim pipe 35 may include an oblique guide surface 36 configured to direct the coarse particles that pass through the entrance 37 of the reclaim pipe 35 to be routed back to the pulverizer. The reclaim pipe 35 may include an exit 46 that may couple directly to the raw solid material feed for the pulverizer or may couple to a carrying pipe that transfers the coarse particles to the pulverizer. The classifier 30 may also include a valve (e.g., trickle, rotary) to discourage fluid flow back through (e.g., up) the reclaim pipe, in the reverse of the reclamation direction.

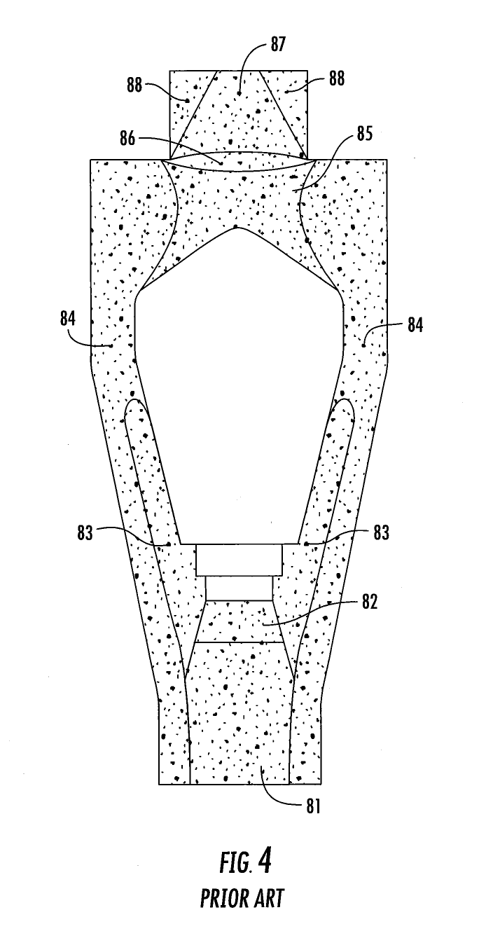

FIGS. 4-10 illustrate predictive analysis performed through Computation Fluid Dynamics (CFD) analysis that compares a conventional axial classifier to an exemplary embodiment of a classifier described herein. These Figures do not illustrate actual testing of classifiers, since CFD analysis is a computer modeling process used for predictive analysis. The typical output generated by CFD analysis are color contour plots having varying color gradients wherein specific colors are assigned to specific values (or magnitudes) of a parameter (e.g., pressure, velocity) using a given unit of measure (e.g., inches of water, meters per second). The hatching used in FIGS. 4-10 is intended to represent these gradients of the parameter evaluated in the CFD analysis by having solid lines demark sections of hatching labeled with a reference numeral that corresponds to a given range of values or magnitudes of that parameter using a given unit of measure. Thus, the hatching used in FIGS. 4-10 is not meant to denote stippling or a material of a structure of the classifier because the hatching used is meant to illustrate portions (or sections) of the classifier where the particles of fluid (e.g., fuel and air) pass through, wherein each portion represents the value discussed below.

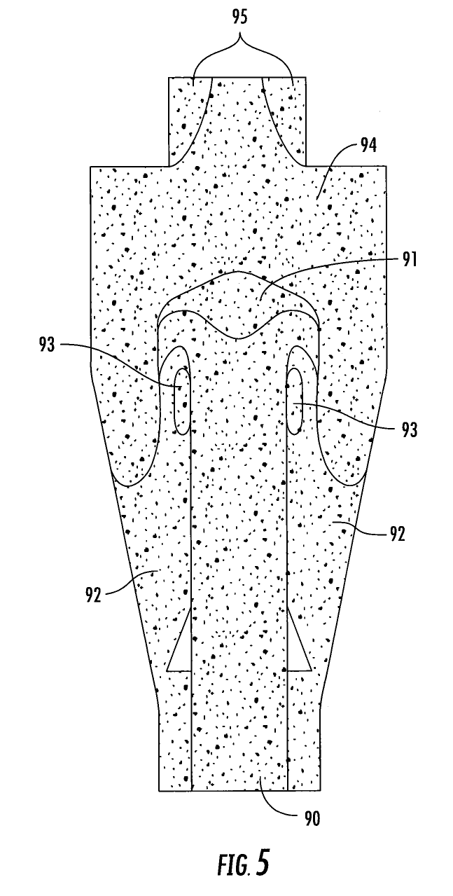

FIG. 4 illustrates the static pressure gradients within the conventional classifier of FIG. 1, while FIG. 5 illustrates the static pressure gradients within an exemplary embodiment of the classifier of FIG. 2. The predictive analysis of FIG. 4 shows that the conventional classifier has a relatively uniform pressure upon exiting the inlet pipe (represented by the magnitude range labeled as gradient 82) until entering the outlet pipe of the classifier (represented by the magnitude range labeled as gradient 86), which suggests that the coarse particles are often unable to overcome the drag force of the fluid flow to fall back into the reclaim pipe. Conversely, the predictive analysis of FIG. 5 shows the classifier configured to produce a pressure drop in the fluid flow exiting the reflective cover and flowing downwardly towards the deflective member (represented by the magnitude ranges labeled as gradients 93 and 92), and another pressure drop as the fluid turns upwardly to flow towards the outlet pipe (represented by the magnitude ranges labeled as gradients 92 and 94). These pressure drops in the fluid flow allow the inertia or momentum of the coarse particles coupled with gravity to overcome the drag force of the fluid flow, so that the coarse particles descend or drop to the reclaim pipe for further size reduction.

As shown in FIG. 4, the magnitude range labeled as gradient 81 corresponds to a predicted pressure gradient of about 2.80 inches of water (in H₂0), the magnitude range labeled as gradient 82 corresponds to a predicted pressure gradient of about 3.15 inches of water (in H₂0), the magnitude range labeled as gradient 83 corresponds to a predicted pressure gradient of about 2.45 inches of water (in H₂0), the magnitude range labeled as gradient 84 corresponds to a predicted pressure gradient of about 2.10 inches of water (in H₂0), the magnitude range labeled as gradient 85 corresponds to a predicted pressure gradient of about 1.95 inches of water (in H₂0), the magnitude range labeled as gradient 86 corresponds to a predicted pressure gradient of about 1.75 inches of water (in H₂0), the magnitude range labeled as gradient 87 corresponds to a predicted pressure gradient of about 1.40 inches of water (in H₂0), and the magnitude range labeled as gradient 88 corresponds to a predicted pressure gradient of about 0.70 inches of water (in H₂0). Thus, the predicted pressure within the housing is relatively uniform upon exiting the inlet pipe until entering the outlet pipe, making it difficult for the coarse particles to break free from the drag forces of the fluid flow.

As shown in FIG. 5, the magnitude range labeled as gradient 90 corresponds to a predicted pressure gradient of about 2.65 inches of water (in H₂0), the magnitude range labeled as gradient 91 corresponds to a predicted pressure gradient of about 2.80 inches of water (in H₂0), the magnitude range labeled as gradient 92 corresponds to a predicted pressure gradient of about 1.75 inches of water (in H₂0), the magnitude range labeled as gradient 93 corresponds to a predicted pressure gradient of about 1.50 inches of water (in H₂0), the magnitude range labeled as gradient 94 corresponds to a predicted pressure gradient of about 1.40 inches of water (in H₂0), and the magnitude range labeled as gradient 95 corresponds to a predicted pressure of about 0.70 inches of water (in H₂0). Thus, the predicted pressure within the housing drops upon exiting the reflective cover and then drops again upon turning upwardly by the deflective member. making it easier for the coarse particles to overcome the drag forces of the fluid flow to descend to the reclaim pipe.

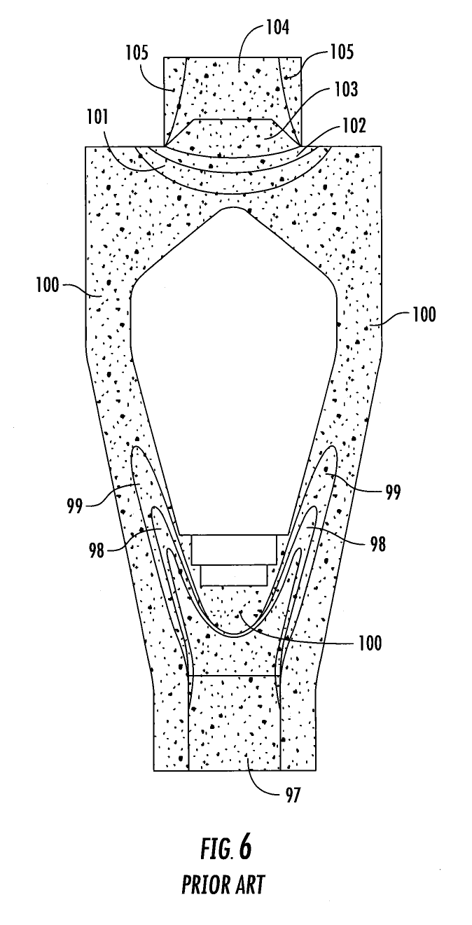

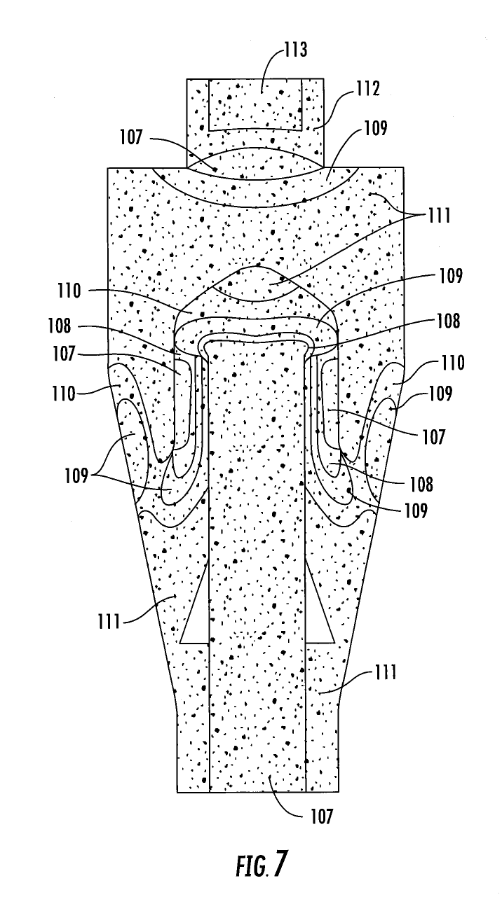

FIG. 6 illustrates the velocity gradients of the fluid flowing within the conventional classifier of FIG. 1, while FIG. 7 illustrates the velocity gradients of the fluid flowing within the exemplary embodiment of the classifier of FIG. 2. The predictive analysis of FIG. 6 shows that the fluid within the conventional classifier has high velocities exiting the inlet pipe (represented by the magnitude range labeled as gradient 97), then there is a significant velocity gradient as the flow transitions form the inlet pipe to the passage between the target cone member and the housing. The velocity of the fluid remains relatively low as the fluid passes through the passage formed between the cone member and the housing (represented by the magnitude range labeled as gradient 100) until reaching the outlet pipe (represented by the magnitude range labeled as gradient 103). This uniform velocity in the upward direction illustrates why the conventional classifier passes a larger percentage of coarse particles through the outlet pipe, since the inertia of the particles are in the same direction as the drag forces generated by the fluid flow which travels substantially upward throughout the length of the passage. In order for the particles to be reclaimed and rejected back to the pulverizer, the gravitational force must overcome both the particle inertia, created by the high classifier inlet velocity, and the drag force of the fluid flow.

Conversely, the predictive analysis of FIG. 7 shows the fluid velocities exiting the reflective cover to be relatively high, but then decrease as the fluid flow and particles descend through the classifier toward the deflecting member, allowing the coarse particles to be reclaimed. The inertia of the coarse particles coupled with gravitational force offset the fluid drag forces, which makes it difficult for the coarse particles to remain entrained in the fluid flow. Additionally, FIG. 7 shows that after being turned upwardly (e.g., influenced by the deflecting member), the velocity of the fluid decreases when passing between the reflecting cover and the housing (in the cavity) reducing the drag forces and allowing remaining coarse particles to overcome the drag forces and descend to be reclaimed. The drop in velocity magnitudes in the regions of the magnitude ranges labeled as gradients 109, 110 and 111 allow the coarse particles to overcome the drag forces to descend downwardly toward the reclaim pipe.

As shown in FIG. 6, the magnitude range labeled as gradient 97 corresponds to a predicted velocity magnitude gradient of about 16.8 meters per second (m/s), the magnitude range labeled as gradient 98 corresponds to a predicted velocity magnitude gradient of about 10.5 meters per second (m/s), the magnitude range labeled as gradient 99 corresponds to a predicted velocity magnitude gradient of about 8.4 meters per second (m/s), the magnitude range labeled as gradient 100 corresponds to a predicted velocity magnitude gradient of about 4.2 meters per second (m/s), the magnitude range labeled as gradient 101 corresponds to a predicted velocity magnitude gradient of about 8.4 meters per second (m/s), the magnitude range labeled as gradient 102 corresponds to a predicted velocity magnitude gradient of about 10.5 meters per second (m/s), the magnitude range labeled as gradient 103 corresponds to a predicted velocity magnitude gradient of about 16.8 meters per second (m/s), the magnitude range labeled as gradient 104 corresponds to a predicted velocity magnitude gradient of about 21.0 meters per second (m/s), and the magnitude range labeled as gradient 105 corresponds to a predicted velocity magnitude gradient of about 18.9 meters per second (m/s). The relatively high velocity of the particles exiting the inlet pipe (represented by magnitude range labeled as gradient 97) pushes the particles upwardly through the passage formed between the cone member and the housing, then the relatively uniform velocity in the regions of the magnitude range labeled as gradient 99 and the magnitude range labeled as gradient 100 make it difficult for the coarse particles to break free from the drag forces of the fluid flow, which results in a relatively large number of coarse particles passing through the outlet pipe.

As shown in FIG. 7, the magnitude range labeled as gradient 107 corresponds to a predicted velocity magnitude gradient of about 16.8 meters per second (m/s), the magnitude range labeled as gradient 108 corresponds to a predicted velocity magnitude gradient of about 10.5 meters per second (m/s), the magnitude range labeled as gradient 109 corresponds to a predicted velocity magnitude gradient of about 8.4 meters per second (m/s), the magnitude range labeled as gradient 110 corresponds to a predicted velocity magnitude gradient of about 6.3 meters per second (m/s), the magnitude range labeled as gradient 111 corresponds to a predicted velocity magnitude gradient of about 4.2 meters per second (m/s), the magnitude range labeled as gradient 112 corresponds to a predicted velocity magnitude gradient of about 16.8 meters per second (m/s), and the magnitude range labeled as gradient 113 corresponds to a predicted velocity magnitude gradient of about 21.0 meters per second (m/s).

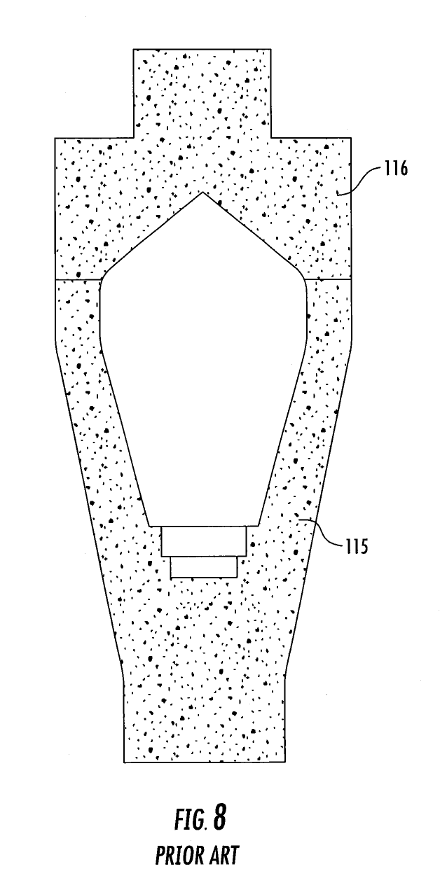

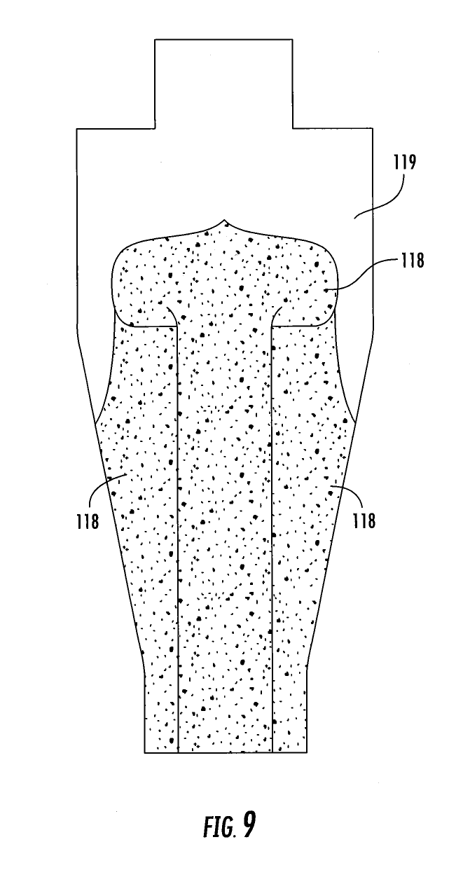

FIG. 8 illustrates the concentration of the flow of the coarse particles (here particles having diameters greater than 300 microns or micrometers) within the conventional classifier of FIG. 1, while FIG. 9 illustrates the concentration of the flow of the coarse particles within the exemplary embodiment of the classifier of FIG. 2. In other words, FIGS. 8 and 9 show the concentration of coarse particles relative to the interior regions or portions of the chambers of the respective classifier in which the fluid flows therethrough. The predictive analysis of FIG. 8 shows that 76.9 percent of the coarse particles are reclaimed, while 23.1 percent of the coarse particles pass through the outlet pipe of the conventional classifier and into the combustion zone. Thus, 100 percent of the coarse particles travel through the interior portion of the chamber labeled with reference numeral 115, with 76.9 percent being reclaimed (or separated) and with 23.1 percent of the coarse particles passing through the interior portion of the chamber labeled with reference numeral 116 to exit the classifier through the outlet pipe.

However, the predictive analysis of FIG. 9 shows that 100 percent of the coarse particles are reclaimed and hence, 0 (zero) percent of the coarse particles pass through the outlet pipe of the classifier of FIG. 2. Thus, 100 percent of the coarse particles travel through the interior portion of the chamber labeled with reference numeral 118, with all 100 percent being reclaimed (or separated) and with 0 percent of the coarse particles passing through the interior portion of the chamber labeled with reference numeral 119 to exit the classifier through the outlet pipe. The CFD analysis predicts that the classifier as disclosed herein will be significantly more efficient than conventional classifiers at separating coarse particles to be reclaimed, therefore increasing the combustion efficiency of the overall power source.

The results of the CFD analysis are further illustrated in Tables 1-3 below. Table 1 illustrates the particle size distribution used by the CFD analysis. The results from Tables 1 and 2 show that the classifier of FIG. 2 is more efficient at separating coarse particles to be reclaimed and passing fine particles to the combustion zone, relative to the conventional classifier of FIG. 1. For example, the whole reclaim percentage was increased from 24.2 percent for the conventional classifier to 44 percent for the classifier of FIG. 2. Further, the classifier of FIG. 2 reclaimed 100 percent of the particles greater than 300 microns, compared to 76.9 percent of particles the same sized being reclaimed by the conventional classifier. The classifier of FIG. 2 reclaimed 98.5 percent of the particles sized from 150 microns to 300 microns, compared to 60.5 percent of particles in the same size range being reclaimed by the conventional classifier. This illustrates that the classifier of FIG. 2 increases the combustion efficiency by sending a higher percentage of fine particles to the combustion zone, while sending the coarse particles to be reclaimed. Additionally, the “Measured Mass Percent (%)” correlates well to the “Mass Percent (%)”, which is suggestive of a high level of accuracy from the CFD analysis.

TABLE 1
Amount of Inlet Mass Flow based on particle Size (or size range) used in CFD Analysis

| Particle Size Range | >300 μm | 150 μm-300 μm | 75 μm-150 μm | <75 μm | Total |
|---|---|---|---|---|---|
| Inlet Mass Flow | 0.673 | 2.355 | 4.374 | 6.056 | 13.458 |
| (kg/s) | | | | | |

TABLE 2
CFD Analysis Results for the
Conventional Classifier of FIG. 1
Conventional (baseline) Classifier of FIG. 1

| | | | | |
|---|---|---|---|---|
| Percent (%) to Reclaim | 24.2% | | | |
| Particle Size Range | >300 μm | 150 μm- | 75 μm- | <75 μm |
| | | 300 μm | 150 μm | |
| Inlet Mass | 0.673 | 2.355 | 4.374 | 6.056 |
| Flow (kg/s) | | | | |

Exiting the Outlet Pipe (to Combustion Zone)

| | | | | |
|---|---|---|---|---|
| Mass Flow (kg/s) | 0.156 | 0.930 | 3.059 | 6.056 |
| Mass Percent (%) | 1.5 | 9.1 | 30.0 | 59.4 |
| Measured Mass | 1.5 | 8.8 | 29.3 | 60.4 |
| Percent (%) | | | | |

Entering the Reclaim Pipe

| | | | | |
|---|---|---|---|---|
| Reclaim Mass | 0.517 | 1.425 | 1.314 | 0.000 |
| Flow (kg/s) | | | | |
| Percent (%) of size | 76.9 | 60.5 | 30.1 | 0.0 |
| Range Reclaimed | | | | |

TABLE 3
CFD Analysis Results for the Classifier of FIG. 2
Classifier of FIG. 2

| | | | | |
|---|---|---|---|---|
| Percent (%) to Reclaim | 44.0% | | | |
| Particle Size Range | >300 μm | 150 μm- | 75 μm- | <75 μm |
| | | 300 μm | 150 μm | |
| Mass Flow (kg/s) | 0.673 | 2.355 | 4.374 | 6.056 |

Exiting the Outlet Pipe (to Combustion Zone)

| | | | | |
|---|---|---|---|---|
| Mass Flow (kg/s) | 0.000 | 0.035 | 1.851 | 5.644 |
| Mass Percent (%) | 0.0 | 0.5 | 24.5 | 75.0 |
| Measured Mass Percent (%) | N/A | N/A | N/A | N/A |

Entering the Reclaim Pipe

| | | | | |
|---|---|---|---|---|
| Reclaim Mass Flow (kg/s) | 0.673 | 2.320 | 2.523 | 0.412 |
| Percent (%) of size Range | 100 | 98.5 | 57.7 | 6.8 |
| Reclaimed | | | | |

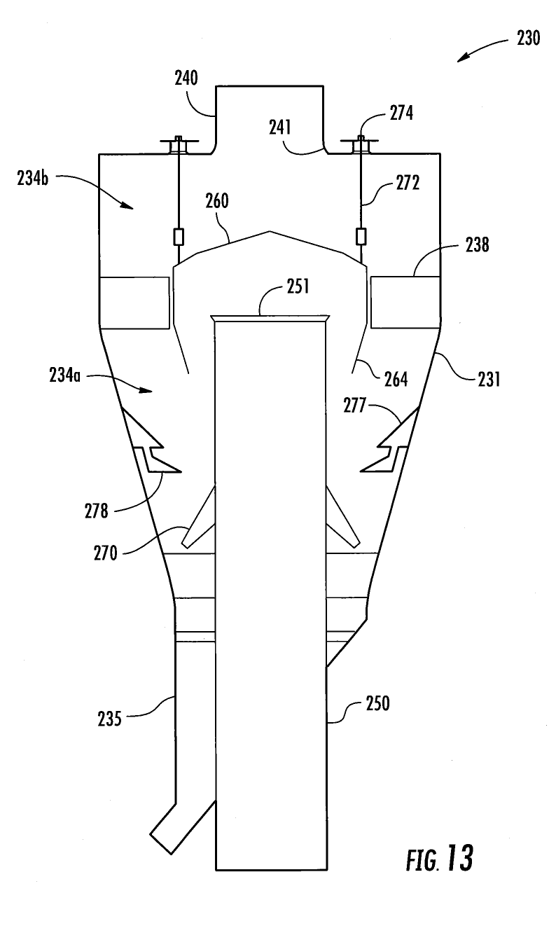

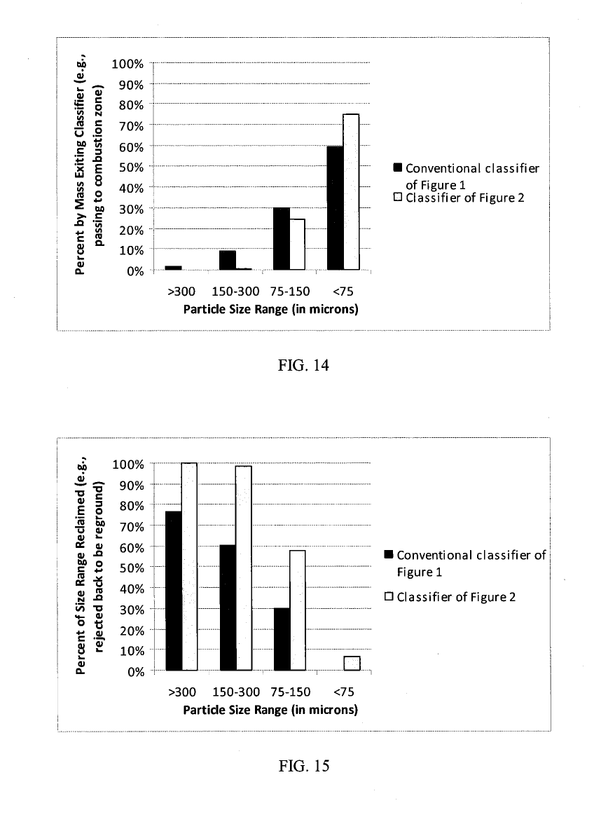

FIGS. 14 and 15 are intended to help illustrate the information provided above in Tables 2 and 3 for the CFD analysis comparing the exemplary classifier of FIG. 2 with the conventional classifier of FIG. 1. FIG. 14 illustrates the percent by mass of the particles size ranges that are predicted (by the CFD analysis) to pass through (e.g., exit) the classifier, such as to be used in the combustion zone. As shown in FIG. 14, the classifier of FIG. 2 passes about zero percent (0%) by mass of the particles having sizes greater than 300 microns, about one half of one percent (0.5%) by mass of the particles having sizes between 150 and 300 microns, about twenty-four and five-tenths percent (24.5%) by mass of the particles having sizes between 75 and 150 microns, and about seventy-five percent (75%) by mass of the particles having sizes less than 75 microns downstream (i.e., exit the classifier to be used for combustion). For comparison, the conventional classifier of FIG. 1 is predicted to pass about one and five-tenths percent (1.5%) by mass of the particles having sizes greater than 300 microns, about nine and one-tenth percent (9.1%) by mass of the particles having sizes between 150 and 300 microns, about thirty percent (30%) by mass of the particles having sizes between 75 and 150 microns, and about fifty-nine and four-tenths percent (59.4%) by mass of the particles having sizes less than 75 microns downstream (i.e., exit the classifier to be used for combustion).

FIG. 15 illustrates the percent of the particles in each specific size range that are predicted (by the CFD analysis) to be separated (e.g., rejected) from the fluid flow by the classifier, such as to be reground for further size reduction. As shown in FIG. 15, the classifier of FIG. 2 is predicted to reject about one hundred percent (100%) of the particles having sizes greater than 300 microns, about ninety-eight and five-tenths percent (98.5%) of the particles having sizes between 150 and 300 microns, about fifty-seven and seven-tenths percent (57.7%) of the particles having sizes between 75 and 150 microns, and about six and eight-tenths percent (6.8%) of the particles having sizes less than 75 microns. For comparison, the conventional classifier of FIG. 1 is predicted to reject about seventy-six and nine-tenths percent (76.9%) of the particles having sizes greater than 300 microns, about sixty and five-tenths percent (60.5%) of the particles having sizes between 150 and 300 microns, about thirty and one-tenth percent (30.1%) of the particles having sizes between 75 and 150 microns, and about six and zero percent (0%) of the particles having sizes less than 75 microns.

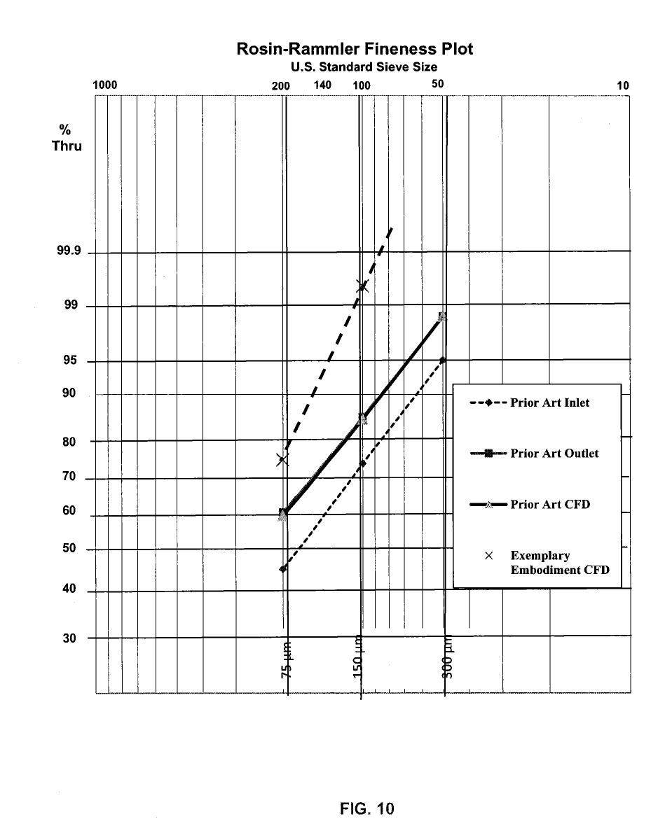

With reference to FIG. 10, a Rosin-Rammler plot illustrating the inlet conditions, conventional classifier conditions, and the classifier of FIG. 2 conditions is shown. The Rosin-Rammler equation is as follows:

$$R = 100 {e}^{- {( \frac{x}{k} )}^{n}} ;$$

where R is the percent (%) material retained, x is the particle size in mm, k is the absolute size constant, and n is the size distribution constant. The x-axis of the Rosin-Rammler plot is on log scale representing the particle sizes plotted at their square hole mm equivalent. The y-axis of the Rosin-Rammler plot is a probability distribution based on the Rosin-Rammler equation above. The value for “n” corresponds to the slope of the line. The plot of FIG. 10 includes actual test data for the inlet and outlet conditions for the conventional classifier of FIG. 1 (which are labeled as “prior art inlet” and “prior art outlet” respectively). The plot of FIG. 10 also includes the predicted results for the outlet conditions for the conventional classifier of FIG. 1 using CFD analysis, as a method establishing confidence of the CFD analysis used. The correlation between the predicted CFD outlet conditions and the actual outlet conditions from the test data provides a strong confidence in the accuracy of the CFD modeling and the results predicted therefrom. The plot of FIG. 10 also shows that the predicted outlet conditions of the classifier of FIG. 2 (labeled as the “Exemplary Embodiment CFD”), which shows an improved output fluid flow that comprises of particles having finer particles along with retaining a higher percentage of coarser particles (relative to the conventional classifier). This further illustrates the increased separation efficiency of the classifier of FIG. 2, relative to the conventional classifier of FIG. 1.

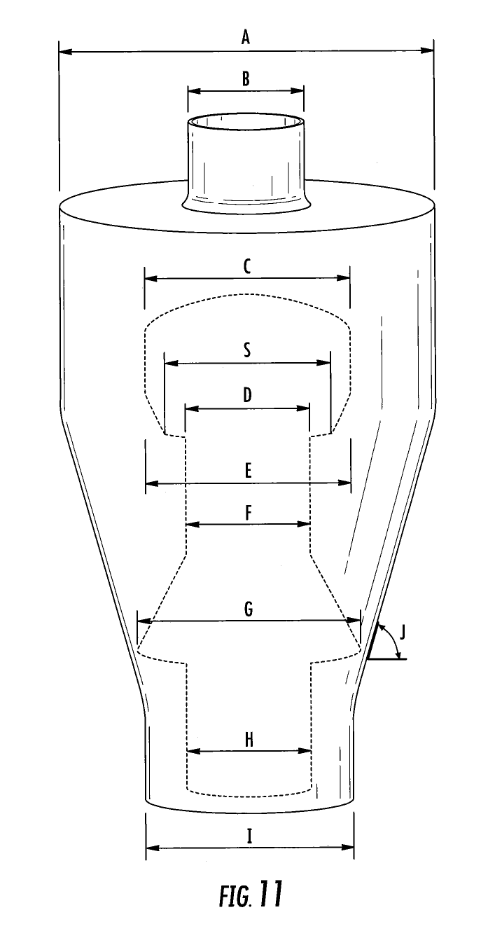

By way of illustration, FIGS. 11 and 12 show dimensions of an exemplary embodiment of a static axial classifier. It should be understood, however, that classifiers having varying dimensions may be utilized according to other exemplary embodiments and the dimensions provided are not limitations. The axial classifier may have an overall height P of about 7400 mm with the outlet pipe having a height L of about 860 mm. Thus, the height of the housing may be about 6540 mm (the height P minus the height L). The annular upper portion of the housing of the axial classifier may have a diameter A of about 4300 mm, while the annular lower portion (below the conical portion) of the housing may have a diameter I of about 2481 mm. The conical portion of the housing may be configured at angle J of about seventy-five degrees (75°) relative to horizontal. The outlet pipe may have a diameter B of about 1404 mm and a height L of about 860 mm. The outlet pipe may also have a transition (e.g., chamfer) having a diameter M of about 1600 mm that extends at an angle K of about forty-five degrees) (45° relative to horizontal from the diameter M. The annular side wall of the reflective cover may have an upper outer diameter C of about 2400 mm (where the top surface and annular side wall come together) and a lower outer diameter E of about 2250 mm (where the annular side wall and the exit portion come together). The exit portion may extend at an angle X of about ten and one-half degrees (10.5°) relative to vertical to a diameter S of about 1984 mm. The top of surface of the reflective cover may be offset from the top of the housing by a length T of about 270 mm. The inlet pipe may have an upper end with a diameter D of about 1560 mm (where the particles cylindrical portion meets the exit portion) and a lower end with a diameter H of about 1404 mm (where the particles enter the inlet pipe). The center portion of the inlet pipe may have a diameter F of about 1404 mm. The exit portion of the inlet pipe may extend at an angle V of about forty-five degrees (45°) relative to vertical a length W of about 618 mm (from the bottom surface of the reflective cover) to an outer diameter U of about 1328 mm. The upper end of the inlet pipe may be configured at a height N of about 2705 mm from the top of the housing. The deflecting member may have an outer diameter G of about 2520 mm (at the bottom of the member) and may extend at an angle R of about sixty degrees (60°) from horizontal a height Q of about 988 mm. It should be noted that the deflecting member may be configured to be adjusted to vary the particle size being reclaimed, so the above dimensions may be nominal settings that may vary when the deflecting member is adjusted. The transition of the housing from the lower annular shape to the conical shape may be at a height 0 of about 3461 mm below the upper end (exit end) of the inlet pipe. The fluid flow guides may be provided at a height AA of about 2066 mm above the transition of the housing from conical to cylindrical. The fluid flow guides may be configured at an angle Y of about sixty degrees (60°) from the conical portion of the housing. The second fluid flow guide may be positioned at a length Z of about 150 mm below the first fluid flow guide. The first fluid flow guide may extend from the conical portion of the housing to a length BB of about 1333.5 mm from the centerline of the inlet pipe. The second fluid flow guide may extend from the conical portion of the housing to a length CC of about 1270 mm from the centerline of the inlet pipe. Again, it is noted that axial classifiers may be configured to have dimensions that vary from those provided in FIGS. 11 and 12 and disclosed above, as these dimensions illustrate an exemplary embodiment of a classifier that is not intended to serve as limiting.

The static axial classifiers described and shown herein may be configured to separate coarse particles of fuel, such as coal, from a fluid flow including the fuel, wherein the fine particles of fuel may be used to generate heat and power in a power plant. For example, the power plant may produce electric power from the combustion of the fuel source, wherein the power plant includes a pulverizer, a combustion device, and an axial classifier provided therebetween. The pulverizer may be configured to reduce the particle size of the fuel source that is input into the pulverizer, then output the fuel having a reduced particle size to the axial classifier. The axial classifier may be configured to separate the particles (e.g., the coarse particles) of fuel from a fluid flow received from the pulverizer. The axial classifier may transfer the separated coarse particles back to the pulverizer and transfer the fine particles to the combustion device. The axial classifier may include an inlet pipe, a reflective cover, a deflecting member, a fluid flow guide, a reclaim pipe fluidly coupled to the pulverizer, and a housing forming a chamber for the fluid flow to pass therein. The inlet pipe may direct the fluid flow received from the pulverizer upwardly toward the reflective cover; wherein the reflective cover may redirect the fluid flow downwardly toward the deflecting member and reclaim pipe. The particles impact other particles, as well as the housing and inlet pipe, inducing forces (e.g., friction forces) that counteract the drag forces from the fluid flow that cause the coarse particles to be separated from the fluid flow and enter the reclaim pipe to pass back through the pulverizer to be resized and allow the fine particles to remain in the fluid flow. The fine particles of the fluid flow are then redirected upwardly toward an opening in the housing to pass into the combustion device, which includes an igniter and a combustion chamber. The igniter may provide the heat to initiate the combustion of the fuel in the combustion chamber.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the classifiers as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An axial classifier for separating the particles of a fluid flow based on the size of the particles, comprising:
an inlet pipe having a first end and a second end, wherein the first end receives the fluid flow from another device and the second end outputs the fluid flow;
a reclaim pipe having an opening configured to receive the particles separated from the fluid flow;
a reflecting cover provided above the inlet pipe for redirecting the fluid flow exiting the inlet pipe toward the reclaim pipe; and
a housing forming a chamber for the fluid flow to flow therein, wherein the housing includes an opening for the fluid flow to exit the classifier;
wherein the second end of the inlet pipe is provided above the opening of the reclaim pipe, and wherein the particles of the fluid flow are separated in the chamber after existing the reflecting cover.

2. The axial classifier of claim 1, wherein the second end of the inlet pipe is contoured to minimize the pressure drop of the fluid flow exiting the inlet pipe.

3. The axial classifier of claim 1, wherein the first end of the inlet pipe receives the fluid flow from a pulverizer that is configured to reduce the particle size of the fluid flow.

4. The axial classifier of claim 1, further comprising a deflecting member provided below the reflecting cover for redirecting the fluid flow received from the reflecting cover in the chamber.

5. The axial classifier of claim 4, further comprising an adjustment mechanism configured to adjust the orientation of the deflecting member relative to the housing.

6. The axial classifier of claim 5, wherein the adjustment mechanism is configured to adjust the elevation of the deflecting member.

7. The axial classifier of claim 5, wherein the adjustment mechanism is configured to adjust the angle of the deflecting member.

8. The axial classifier of claim 5, further comprising a linkage that couples the adjustment mechanism to the deflecting member, such that the adjustment of the adjustment mechanism is communicated to the deflecting member through the linkage.

9. The axial classifier of claim 8, wherein the linkage is a threaded linear actuator.

10. The axial classifier of claim 1, wherein the reflecting cover includes a concave shaped top surface provided above an annular shaped side wall, which redirect the fluid flow exiting the inlet pipe from an upwardly direction to a downwardly direction.

11. The axial classifier of claim 1, wherein the reflecting cover has an exit portion that is contoured to direct the fluid flow exiting the reflecting cover.

12. The axial classifier of claim 1, further comprising an adjustment mechanism configured to adjust the orientation of the reflecting cover relative to the housing.

13. The axial classifier of claim 12, further comprising a linkage that couples the adjustment mechanism to the reflecting cover, such that the adjustment of the adjustment mechanism is communicated to the reflecting cover through the linkage.

14. The axial classifier of claim 1, further comprising a support plate provided in the chamber, wherein the support plate includes an outer surface that is coupled to the housing and an inner surface that is coupled to the reflecting cover.

15. The axial classifier of claim 12, further comprising a support plate provided in the chamber, wherein the support plate includes an outer surface that is coupled to the housing and an inner surface that acts as a guide to the reflecting cover when the reflective cover is adjusted.

16. The axial classifier of claim 1, further comprising a fluid flow guide coupled to the housing and configured to influence the direction of the fluid flow.

17. The axial classifier of claim 16, wherein the fluid flow guide is provided between the reflecting cover and reclaim pipe.

18. A power plant for producing electric power from the combustion of a fuel source, comprising:
a pulverizer configured to reduce the particle size of the fuel source input into the pulverizer;
a combustion device having an igniter and a combustion chamber, wherein the igniter provides the heat to initiate the combustion of the fuel in the combustion chamber; and
an axial classifier configured to separate the particles of fuel of a fluid flow received from the pulverizer and configured to transfer the separated coarse particles back to the pulverizer and transfer the fine particles to the combustion device, wherein the axial classifier includes an inlet pipe, a reflective cover, a deflecting member, a reclaim pipe fluidly coupled to the pulverizer, a fluid flow guide and a housing forming a chamber for the fluid flow to pass therein;
wherein the inlet pipe directs the fluid flow received from the pulverizer upwardly toward the reflective cover;
wherein the reflective cover redirects the fluid flow downwardly toward the deflecting member and reclaim pipe;
wherein the fluid flow guide is coupled to the housing and configured to influence the direction of the fluid flow;
wherein the coarse particles are separated from the fluid flow and enter the reclaim pipe to pass back through the pulverizer to be resized; and
wherein the fine particles of the fluid flow remain in the fluid flow and are redirected upwardly by the deflecting member toward an opening in the housing to pass into the combustion device.

19. The power plant of claim 18, wherein the inlet pipe includes a first end coupled to the pulverizer and a second end to direct the fluid flow toward the reflecting cover, wherein the second end of the inlet pipe is positioned above the opening of the reclaim pipe.

20. The power plant of claim 18, wherein the reflecting cover includes a concave shaped top surface provided above an annular shaped side wall, which redirect the fluid flow exiting the inlet pipe from an upwardly direction to a downwardly direction.
